(19) United States
(12) Patent Application Publication
(10) Pub. No.: US 2026/0117576 A1
(43) Pub. Date: Apr. 30, 2026

(54) Actuating Device for Opening and Closing Cover of Vehicle

(71) Applicant: Illinois Tool Works Inc., Glenview, IL (US)

(72) Inventor: Tengfei Zhang, Shanghai (CN)

(21) Appl. No.: 19/367,502

(22) Filed: Oct. 23, 2025

(30) Foreign Application Priority Data
Oct. 29, 2024 (CN) 202411524196.4

(51) Int. Cl. E05F 15/622

(52) U.S. Cl. CPC E05F 15/622; E05Y 2600/60; E05Y 2900/534

(57) ABSTRACT

The present disclosure provides an actuating device for opening and closing a cover of a vehicle and including an actuator module, a movement trajectory control module and a connecting member. The actuator module includes an output shaft. The movement trajectory control module includes an outer sleeve and an input shaft extending into the outer sleeve. The input shaft is coaxially connected to the output shaft in a form-fit manner. The movement trajectory control module is configured to be driven by the actuator module to move the cover along the output shaft and/or around the output shaft so as to control a movement trajectory of the cover. The connecting member includes a first receiving portion and a second receiving portion which are in connection with each other. The first receiving portion receives the actuator module. The second receiving portion receives the movement trajectory control module. The input shaft extends into the first receiving portion to connect to the output shaft. The outer sleeve of the movement trajectory control module is connected to the second receiving portion in a form-fit manner to limit the movement of the outer sleeve relative to the actuator module along and around the output shaft.

### RELATED APPLICATIONS

The present application claims the benefit of Chinese Patent Application No. 202411524196.4, filed Oct. 29, 2024, titled “Actuating Device for Opening and Closing Cover of Vehicle,” the contents of which are hereby incorporated by reference.

### TECHNICAL FIELD

The present disclosure generally relates to an actuating device (also referred to as an “executing device”), and in particular to an actuating device provided for opening and closing a cover of a vehicle.

### BACKGROUND

In one type of actuating device for opening and closing a cover (e.g., a refueling or charging port cover) of a vehicle, the actuating device includes a push rod for controlling a movement trajectory of the cover. The push rod can be driven by a driver (e.g., a motor) and cooperate with some components to control the cover to rotate, move linearly, or move linearly while rotating (i.e., move spirally). This type of actuating device further includes a gear system for speed control (e.g., speed reduction) of the driver.

### SUMMARY

The present disclosure generally relates to an actuating device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of an actuating device according to an embodiment of the present disclosure.

FIG. 1B is an exploded view of the actuating device shown in FIG. 1A.

FIG. 2A is an exploded view of a movement trajectory control module of the actuating device shown in FIG. 1A.

FIG. 2B is an axial cross-sectional view of the movement trajectory control module of the actuating device shown in FIG. 1A.

FIG. 3A is a perspective view of a connecting member of the actuating device shown in FIG. 1A from one perspective.

FIG. 3B is a perspective view of the connecting member of the actuating device shown in FIG. 1A from another perspective.

FIG. 4A is a perspective view of the actuating device shown in FIG. 1A with a lock nut removed.

FIG. 4B is a partial cross-sectional view of the actuating device shown in FIG. 4A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides an actuating device for opening and closing a cover of a vehicle. The actuating device includes an actuator module, a movement trajectory control module and a connecting member. The actuator module includes an output shaft. The movement trajectory control module includes an outer sleeve and an input shaft extending into the outer sleeve, the input shaft is coaxially connected to the output shaft in a form-fit manner. The movement trajectory control module is configured to be driven by the actuator module to move the cover along the output shaft and/or around the output shaft so as to control a movement trajectory of the cover. The connecting member includes a first receiving portion and a second receiving portion which are in connection with each other. The first receiving portion receives the actuator module, the second receiving portion receives the movement trajectory control module. The input shaft extends into the first receiving portion to connect to the output shaft. The outer sleeve of the movement trajectory control module is connected to the second receiving portion in a form-fit manner to limit the movement of the outer sleeve of the movement trajectory control module relative to the actuator module along the output shaft and around the output shaft.

According to the above actuating device, the second receiving portion is cylindrical. The second receiving portion and the outer sleeve of the movement trajectory control module are provided with a first snap-fit device and a second snap-fit device. The first snap-fit device limits the movement of the outer sleeve of the movement trajectory control module relative to the actuator module along the output shaft, and the second snap-fit device limits the movement of the outer sleeve of the movement trajectory control module relative to the actuator module around the output shaft.

According to the above actuating device, the first snap-fit device includes a first protrusion provided on an outer surface of the outer sleeve of the movement trajectory control module and a first groove provided on an inner surface of the second receiving portion. The first protrusion and the first groove extend around the output shaft, and the first protrusion is received in the first groove.

According to the above actuating device, the second snap-fit device includes at least one second protrusion provided on the outer surface of the outer sleeve of the movement trajectory control module and at least one second groove formed on the inner surface of the second receiving portion. The second groove extends along the output shaft, and the second protrusion is received in the second groove.

According to the above actuating device, the second groove runs through a distal end of the second receiving portion.

According to the above actuating device, the second groove runs through a wall of the second receiving portion.

According to the above actuating device, the second groove extends through and breaks the first groove.

According to the above actuating device, the second protrusion extends outward from the first protrusion.

According to the above actuating device, the second snap-fit device includes four second protrusions and four second grooves, the four second protrusions are arranged symmetrically around the center of the second receiving portion, and the four second grooves are arranged symmetrically around the center of the second receiving portion.

According to the above actuating device, it further includes a lock nut sleeved on the second receiving portion and connected to the second receiving portion in a threaded manner.

According to the above actuating device, the actuator module is connected to the first receiving portion of the connecting member by means of a fastener.

According to the above actuating device, the input shaft includes an external spline provided thereon, the output shaft includes an internal spline provided therein, and the input shaft is connected to the output shaft by means of the cooperation between the external spline and the internal spline.

An actuating device according to embodiments of the present disclosure is used for opening and closing a cover of a vehicle. The actuating device uses a modular structural design and enables a quick detachable connection between modules. Specifically, in the actuating device according to the embodiments of the present disclosure, a driving device and a gear system are provided as an independent actuator module (also referred to as an “executor module”), components for controlling the rotation and/or linear movement of the cover are provided as an independent movement trajectory control module, and the two modules are connected in a compact and reliable manner to achieve power transmission from the actuator module to the movement trajectory control module.

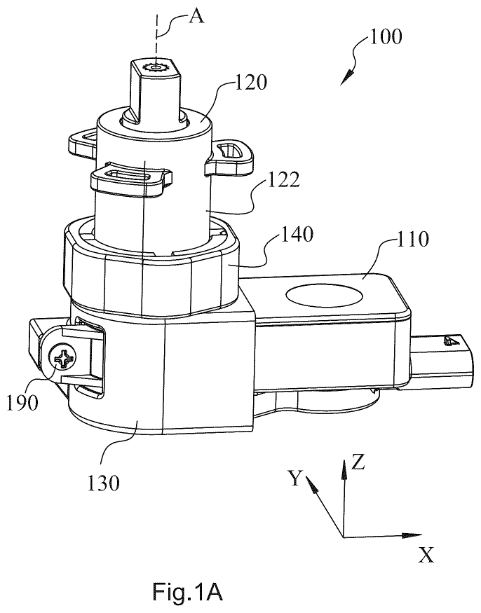

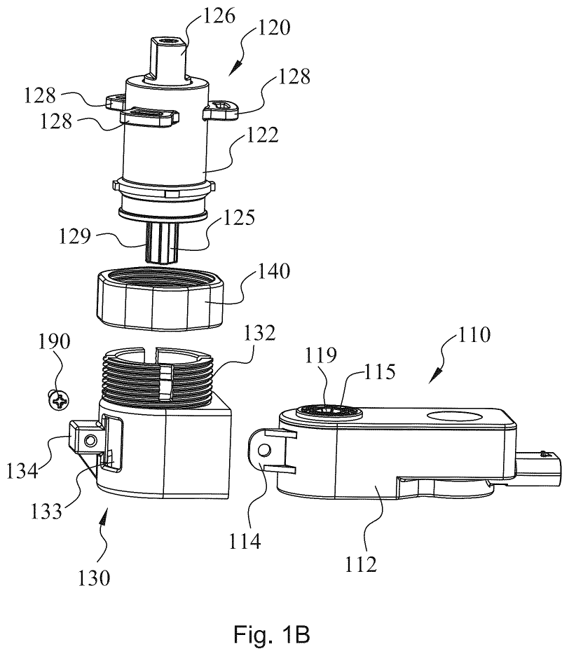

FIGS. 1A and 1B show an overall structure of an actuating device 100 according to an embodiment of the present disclosure. FIG. 1A is a perspective view of the actuating device 100, and FIG. 1B is an exploded view of the actuating device 100.

As shown in FIGS. 1A and 1B, the actuating device 100 includes an actuator module 110, a movement trajectory control module 120, a connecting member 130, a lock nut 140, and a fastener 190. The connecting member 130 detachably connects the actuator module 110 with the movement trajectory control module 120, the lock nut 140 is configured to lock the movement trajectory control module 120 with the connecting member 130, and the fastener 190 is configured to fasten the actuator module 110 and the connecting member 130 together. The actuating device 100 has a length direction X, a width direction Y and a height direction Z. The height direction Z of the actuating device 100 is consistent with a direction of an axis A of the actuator module 110 (and the movement trajectory control module 120), and the length direction X and the width direction Y of the actuating device 100 are substantially consistent with extension directions of an opening (such as a refueling or charging port of a vehicle) covered by a cover of the vehicle actuated by the actuating device.

The actuator module 110 is visually an integrated part, and includes an actuator module housing 112, a driver (e.g., a motor) arranged in the actuator module housing 112, and a gear set (not shown) for reducing the speed of the driver. The actuator module further has an output shaft 115 for outputting a driving force. In FIGS. 1A and 1B, the axis A of the output shaft 115 extends in upward and downward directions (i.e., the height direction of the actuating device 100).

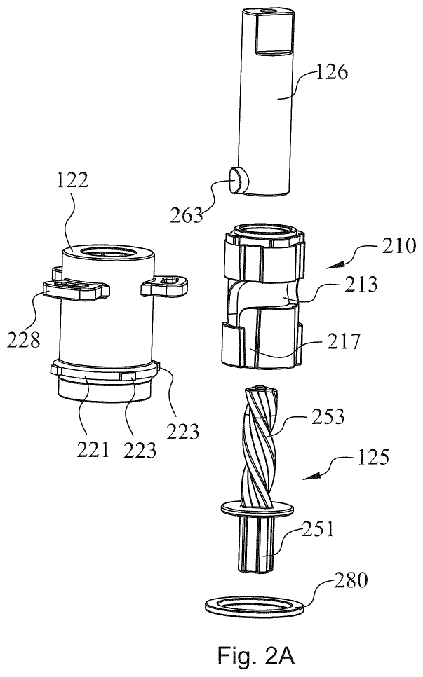

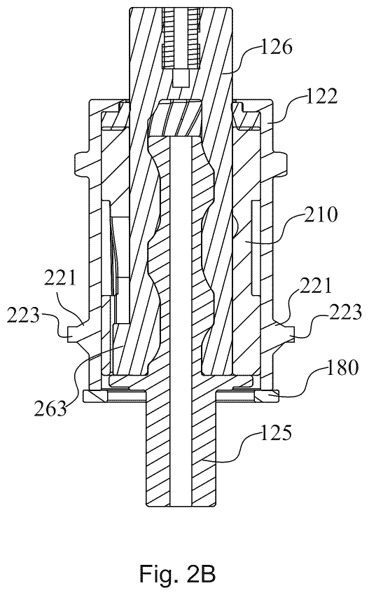

The movement trajectory control module 120 is also visually an integrated part, and includes an outer sleeve 122, an input shaft 125, a push rod 126, and an inner sleeve 210 (as shown in FIG. 2A) which is not shown in FIGS. 1A and 1B. The input shaft 125 and the push rod 126 are connected in a screw transmission manner and both partially extend into the inner sleeve 210, the inner sleeve 210 can cooperate with the push rod 126 to control a movement trajectory of the push rod 126, and the outer sleeve 122 can cooperate with the inner sleeve 210 to limit the rotation of the inner sleeve 210.

The connecting member 130 is shell-shaped and includes a first receiving portion 131 and a second receiving portion 132. The first receiving portion 131 is configured to receive the actuator module 110. The second receiving portion 132 is substantially cylindrical and is configured to receive the movement trajectory control module 120. The interiors of the first receiving portion 131 and the second receiving portion 132 are in connection with each other, and receiving directions thereof are substantially perpendicular to each other. Thus, the input shaft 125 of the movement trajectory control module 120 can extend from the second receiving portion 132 into the first receiving portion 131 and be coaxially connected to the output shaft 115 of the actuator module 110.

The outer sleeve 122 of the movement trajectory control module 120 is connected to the second receiving portion 132 in a form-fit manner to limit the movement of the outer sleeve 122 of the movement trajectory control module 120 relative to the actuator module 110 along the output shaft 115 and about the output shaft 115.

When the movement trajectory control module 120 is received in place in the second receiving portion 132, the lock nut 140 is sleeved on the second receiving portion 132 and connected to the second receiving portion 132 in a threaded manner to lock the outer sleeve 122 of the receiving movement trajectory control module 120 with the second receiving portion 132. To this end, the second receiving portion 132 is provided with an external thread on an outer surface thereof.

The output shaft 115 and the input shaft 125 are connected in a form-fit manner and thus enable a quick detachable connection between them. As shown in FIG. 1B, the output shaft 115 includes a receiving hole provided with an internal spline 119, and the input shaft 125 is provided with an external spline 129 on an outer surface thereof, so that the input shaft 125 is connected to the output shaft 115 by means of the cooperation between the external spline 129 and the internal spline 119.

The second receiving portion 132 of the connecting member 130 is provided with a hole 133 and a connecting boss 134. The actuator module housing 112 is provided with a connecting tab 114. The connecting tab 114 passes through the hole 133 and is aligned with the connecting boss 134, so that the fastener 190 can pass through the holes in the connecting boss 134 and the connecting tab 144 to fasten the actuator module 110 and the connecting member 130 together.

After being assembled in place as shown in FIG. 1A, the outer sleeve 122 of the movement trajectory control module 120 is secured to the connecting member 130, and the actuator module housing 112 is also secured to the connecting member 130, so that when the actuator module 110 outputs power, the outer sleeve 122 of the movement trajectory control module 120 will not separate from the actuator module 110, nor will it rotate around the axis and move along the axis relative to the actuator module 110.

FIGS. 2A and 2B show the specific structure of the movement trajectory control module 120. FIG. 2A is an exploded view of the movement trajectory control module 120, and FIG. 2B is an axial cross-sectional view of the movement trajectory control module 120. As shown in FIGS. 2A and 2B, the outer sleeve 122, the inner sleeve 210, the input shaft 125 and the push rod 126 of the movement trajectory control module 120 are coaxially arranged. The top of the push rod 126 is connected to the cover of the vehicle, such as a refueling or charging port cover.

The input shaft 125 includes a spiral portion 253 at an upper portion thereof, and a portion provided with a spline 251 is located at a lower portion of the input shaft 125. The push rod 126 is substantially cup-shaped, with a closed top and an open bottom, and has a receiving portion provided with an internal thread. The spiral portion 253 of the input shaft 125 extends into the receiving portion of the push rod 126, enabling a threaded connection between the push rod 126 and the input shaft 125. In this way, when the input shaft 125 rotates with the output shaft 115, the push rod 126 can be driven by the input shaft 125 to move.

The movement trajectory of the push rod 126 is defined by the inner sleeve 210. The inner sleeve 210 is cylindrical, with an open top and an open bottom, so that the push rod 126 can axially pass through the inner sleeve 210. A track groove 213 is provided in a wall of the inner sleeve 210, and a limiting protrusion 263 is provided on the push rod 126. The limiting protrusion 263 is received in the track groove 213 and movable along the track groove 213. By configuring the extension direction of the track groove 213, the push rod 126 can move along a predetermined track. For example, the extension of a section of the track groove around the axis enables the push rod 126 to only rotate without moving axially, and the extension of a section of the track groove along the axis enables the push rod 126 to only move axially without rotating. For a cover of a vehicle, such as a refueling or charging port cover, the push rod 126 only rotating without moving axially can rotate the refueling or charging port cover away from a position above the refueling or charging port, so that an operator can perform a refueling or charging operation. The push rod 126 only moving axially without rotating can raise or lower the refueling or charging port cover, so as to open or close the refueling or charging port. In some applications, to perform a refueling or charging operation, the refueling or charging port cover is first raised by the actuating device 100 and then rotated away from the position above the refueling or charging port. After the refueling or charging operation is completed, the refueling or charging port cover is first rotated back to the position above the refueling or charging port by the actuating device 100 and then lowered to cover the refueling or charging port.

The inner sleeve 210 itself cannot rotate around the output shaft 115 because the rotation of the outer sleeve 122 is limited by an external device, and the inner sleeve 210 is connected to the outer sleeve 122 in a form-fit manner and is thus limited from rotating by the outer sleeve 122. The inner sleeve 210 is also unable to move along the output shaft 115 because it is axially clamped between the outer sleeve 122 and a stopper 280. The form-fit between the inner sleeve 210 and the outer sleeve 122 is achieved by providing axially extending grooves 217 on the outer surface of the inner sleeve 210 and providing mating protrusions (not shown) on an inner surface of the outer sleeve 122.

The outer sleeve 122 is further provided with three lugs 128 for connecting the outer sleeve 122 to the external device to limit the movement of the outer sleeve 122. The three lugs 128 are arranged symmetrically around the outer sleeve 122.

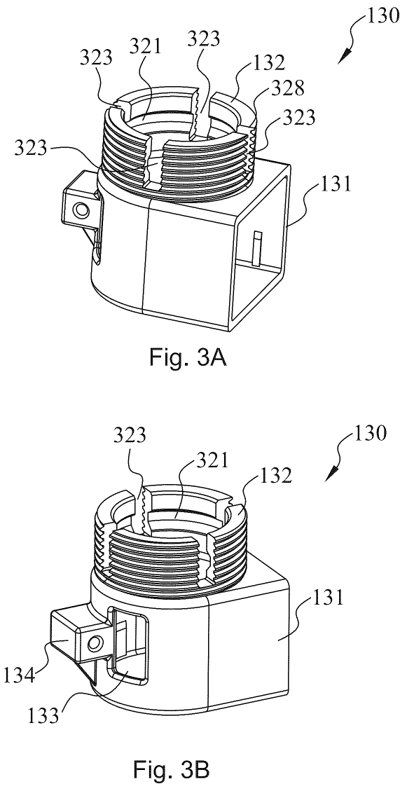

FIGS. 3A and 3B show a specific structure of the connecting member 130. FIG. 3A is a perspective view of the connecting member 130 from one perspective, and FIG. 3B is a perspective view of the connecting member 130 from another perspective. As shown in FIGS. 3A and 3B, the second receiving portion 132 of the connecting member 130 is located above the first receiving portion 131. The second receiving portion 132 is designed to receive a portion of the movement trajectory control module 120, and the first receiving portion 131 is designed to receive a portion of the actuator module 110.

The outer contour shape of the first receiving portion 131 is substantially the same as the outer contour shape of the portion of the actuator module 110 it receives. In the length direction X of the actuating device 100, the first receiving portion 131 is thicker than the actuator module 110 by only one wall thickness. In the width direction Y of the actuating device 100, the first receiving portion 131 is thicker than the actuator module 110 by only two wall thicknesses. The outer contour shape of the second connecting portion 132 is substantially the same as the outer contour shape of the outer sleeve 122 of the movement trajectory control module 120 it receives. In the length direction X and the width direction Y of the actuating device 100, the second receiving portion 132 is thicker than the outer sleeve 122 of the movement trajectory control module 120 by only two wall thicknesses. As shown in FIG. 1A, after the lock nut 140 is in threaded engagement with the second receiving portion 132, the lock nut 140 only slightly exceeds the outer contour of the first receiving portion 131 in the width direction Y of the actuating device 100, and the lock nut 140 does not exceed the outer contour of the first receiving portion 131 in the length direction X of the actuating device 100.

Thus, after the actuating device 100 is assembled in place, the outer contour of the actuating device 100 may be made small in dimension in its length direction X and width direction Y, so as not to occupy too much space of the opening covered by the cover actuated by the actuating device.

As shown in FIGS. 3A, 3B, 2A and 2B, the second receiving portion 132 of the connecting member 130 and the outer sleeve 122 of the movement trajectory control module 120 are provided with a first snap-fit device for limiting the movement of the outer sleeve 122 of the movement trajectory control module 120 relative to the actuator module 110 along the output shaft 115. The first snap-fit device includes a first protrusion 221 provided on an outer surface of the outer sleeve 122 of the movement trajectory control module 120 and a first groove 321 provided on an inner surface of the second receiving portion 132. The first protrusion 221 and the first groove 321 extend around the output shaft 115, and the first protrusion 221 can be received in the first groove 321.

The second receiving portion 132 of the connecting member 130 and the outer sleeve 122 of the movement trajectory control module 120 are provided with a second snap-fit device for limiting the movement of the outer sleeve 122 of the movement trajectory control module 120 relative to the actuator module 110 around the output shaft 115. The second snap-fit device includes four second protrusions 223 provided on the outer surface of the outer sleeve 122 of the movement trajectory control module 120 and four second grooves 323 formed in the inner surface of the second receiving portion 132. The second grooves 323 extend along the output shaft 115, and the second protrusions 223 can be received in the second grooves 323. The four second protrusions and the four second grooves are arranged symmetrically around the center of the second receiving portion 132. It should be noted that, in other embodiments, the number of the second grooves and the second protrusions is not limited to four, and at least one is sufficient.

Still as shown in FIGS. 3A and 3B, the second grooves 323 also serve as guide slots that guide the movement of the outer sleeve 122 of the movement trajectory control module 120 during insertion into the second receiving portion 132 of the connecting member 130. To this end, the second groove 323 runs through a distal end 328 of the second receiving portion 132, that is, an end away from the first receiving portion 131.

In addition, the second groove 323 also runs through a wall of the second receiving portion 132 to circumferentially divide the second receiving portion 132 into four sections that form elastic cantilevers. The second groove 323 also extends through and breaks the first groove 321. In this way, the four sections of the second receiving portion 132 have better elasticity, making it easier for the first protrusion 221 on the outer surface of the outer sleeve 122 of the movement trajectory control module 120 to be inserted into the first groove 321 of the second receiving portion 132.

Still referring to FIGS. 2A and 2B, the second protrusion 223 is provided on the first protrusion 221 and extends outward from the first protrusion 221.

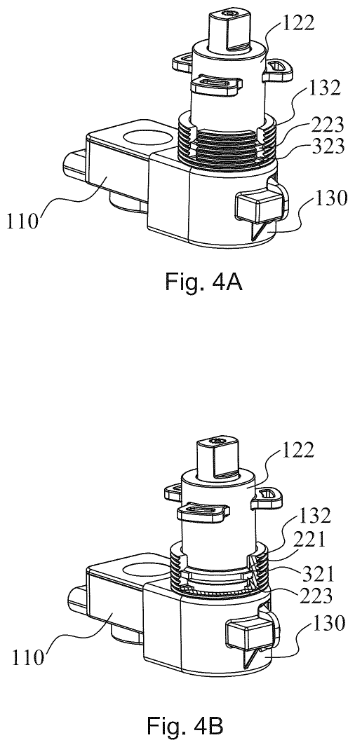

FIGS. 4A and 4B show the first snap-fit device and the second snap-fit device in an assembled state. FIG. 4A is a perspective view of the actuating device 100 with the lock nut 140 removed, and FIG. 4B is a partial cross-sectional view of the actuating device. In FIG. 4B, one of the sections of the second receiving portion 132 of the connecting member 130 is removed.

As shown in FIG. 4A, the second protrusions 223 of the second snap-fit device are respectively received in the corresponding second grooves 323, so that the second snap-fit device can limit the rotation of the outer sleeve 122 relative to the connecting member 130 and thus limit the rotation of the outer sleeve 122 relative to the actuator module 110 secured to the connecting member 130. Since the second protrusions 223 can move along the second grooves 323 and the second grooves 323 extend along the axial direction of the output shaft 115, the outer sleeve 122 of the movement trajectory control module 120 can be axially inserted into the second receiving portion 132 of the connecting member 130 by means of the cooperation between the second protrusions 223 and the second grooves 323, so that the first protrusion 221 applies a uniform push force to the second receiving portion 132 during insertion into the first groove 321. In addition, by identifying the relative positions of the second grooves 323 and the lugs 128 on the outer sleeve 122, the movement trajectory control module 120 may be inserted into the second receiving portion 132 in a predetermined rotational position.

As shown in FIG. 4B, the first protrusion 221 of the first snap-fit device is received in the first groove 321, so that the first snap-fit device can limit the axial movement of the outer sleeve 122 relative to the connecting member 130 and thus limit the axial movement of the outer sleeve 122 relative to the actuator module 110 secured to the connecting member 130.

The actuating device according to the embodiments of the present disclosure uses a modular structural design in which the driving device and the gear system are provided as an independent actuator module, components for controlling the rotation and/or linear movement of the cover are provided as an independent movement trajectory control module, the two modules are connected by a shell-shaped connecting member, and the connecting member is connected to the movement trajectory control module in a form-fit manner. Thus, the two modules can be reliably connected while enabling a quick detachable connection between the two modules, and the space occupied by the connecting member can also be reduced. In addition, in the actuating device according to the embodiments of the present disclosure, the lock nut is used to lock the connection between the two modules, and the lock nut will also not occupy too much space. In this way, the actuating device of the present disclosure is compact in overall dimension, especially in the length direction and the width direction, and can be adapted to the needs of small space applications. Since the modular connection and assembly mentioned above can be achieved, in the actuating device of the present disclosure, actuator modules and movement trajectory control modules with different operating characteristics can be selected for combination as required, thereby expanding the scope of application of the actuating device. For example, an actuator module with larger driving capability may be selected, or an actuator module with smaller driving capability may be selected. For another example, a movement trajectory control module having a push rod that cannot move spirally may be selected, or a movement trajectory control module having a push rod that can move spirally may be selected.

Although the present disclosure is described with reference to the examples of the embodiments, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

What is claimed is:

1. An actuating device for opening and closing a cover of a vehicle, the actuating device comprising:
an actuator module comprising an output shaft;
a movement trajectory control module comprising an outer sleeve and an input shaft extending into the outer sleeve, the input shaft being coaxially connected to the output shaft in a form-fit manner, wherein the movement trajectory control module is configured to be driven by the actuator module to move the cover along the output shaft and/or around the output shaft so as to control a movement trajectory of the cover; and
a connecting member comprising a first receiving portion and a second receiving portion which are in connection with each other, the first receiving portion receiving the actuator module, the second receiving portion receiving the movement trajectory control module, and the input shaft extending into the first receiving portion to connect to the output shaft;
wherein the outer sleeve of the movement trajectory control module is connected to the second receiving portion in a form-fit manner to limit the movement of the outer sleeve of the movement trajectory control module relative to the actuator module along the output shaft and around the output shaft.

2. The actuating device according to claim 1, wherein the second receiving portion is cylindrical, the second receiving portion and the outer sleeve of the movement trajectory control module are provided with a first snap-fit device and a second snap-fit device, the first snap-fit device limiting the movement of the outer sleeve of the movement trajectory control module relative to the actuator module along the output shaft, and the second snap-fit device limiting the movement of the outer sleeve of the movement trajectory control module relative to the actuator module around the output shaft.

3. The actuating device according to claim 2, wherein the first snap-fit device comprises a first protrusion provided on an outer surface of the outer sleeve of the movement trajectory control module and a first groove provided on an inner surface of the second receiving portion, the first protrusion and the first groove extending around the output shaft, and the first protrusion being received in the first groove.

4. The actuating device according to claim 3, wherein the second snap-fit device comprises at least one second protrusion provided on the outer surface of the outer sleeve of the movement trajectory control module and at least one second groove formed on the inner surface of the second receiving portion, the second groove extending along the output shaft, and the second protrusion being received in the second groove.

5. The actuating device according to claim 4, wherein the second groove runs through a distal end of the second receiving portion.

6. The actuating device according to claim 5, wherein the second groove runs through a wall of the second receiving portion.

7. The actuating device according to claim 4, wherein the second groove extends through and breaks the first groove.

8. The actuating device according to claim 4, wherein the second protrusion extends outward from the first protrusion.

9. The actuating device according to claim 4, wherein the second snap-fit device comprises four second protrusions and four second grooves, the four second protrusions being arranged symmetrically around the center of the second receiving portion, and the four second grooves being arranged symmetrically around the center of the second receiving portion.

10. The actuating device according to claim 6, further comprising:
a lock nut sleeved on the second receiving portion and connected to the second receiving portion in a threaded manner.

11. The actuating device according to claim 1, wherein the actuator module is connected to the first receiving portion of the connecting member via a fastener.

12. The actuating device according to claim 1, wherein the input shaft comprises an external spline provided thereon, the output shaft comprises an internal spline provided therein, and the input shaft is connected to the output shaft via the cooperation between the external spline and the internal spline.
